(19) United States
(12) Patent Application Publication
(10) Pub. No.: US 2023/0294785 A1
(43) Pub. Date: Sep. 21, 2023

(54) BLIND SPOT DETECTION SYSTEM

(71) Applicant: TVS MOTOR COMPANY LIMITED, Chennai (IN)

(72) Inventors: Choudhary Kanika, Chennai (IN); Mohan Barath, Chennai (IN); Sharma Abhishek, Chennai (IN); Sai Praveen Velagapudi, Chennai (IN); Venkata Manga Raju Karanam, Chennai (IN)

(73) Assignee: TVS MOTOR COMPANY LIMITED, Chennai (IN)

(21) Appl. No.: 18/004,201

(22) PCT Filed: Jul. 16, 2021
(86) PCT No.: PCT/IN2021/050688

§ 371 Date: Jan. 4, 2023

(30) Foreign Application Priority Data
Jul. 18, 2020 (IN) 202041030739

(51) Int. Cl. B62J 45/41; B62J 50/21

(52) U.S. Cl. CPC B62J 45/41; B62J 50/21

(57) ABSTRACT

A blind spot detection system for a vehicle includes: a sensor unit; a controller; and an alert indication unit, the sensor unit including a left blind spot sensor, a right blind spot sensor and a rear blind spot sensor, the left blind spot sensor being located on one side of the vehicle with respect to a longitudinal mid plane axis of the vehicle, the right blind spot sensor being located on another side of the vehicle with respect to the longitudinal mid plane axis of the vehicle, the left blind spot sensor and the right blind spot sensor being located to detect objects in blind spot areas of the vehicle, and the rear blind spot sensor being located rearwardly of the vehicle and located to detect objects in blind spot areas.

### TECHNICAL FIELD

The present subject matter relates to a vehicle. More particularly, the present subject matter relates to the blind spot detector in the vehicle.

### BACKGROUND

Blind spot detectors have been developed in order to detect the presence of a vehicle or other object in rider's blind spot. The rider's blind spot is that portion of the vehicle in which an object will not normally be observed by the use of interior and exterior mirrors of the vehicle. By detecting the presence of the object in the rider's blind spot, the blind spot detector is useful in assisting the rider in performing a preventive maneuver evaluation of the environment surrounding the vehicle in anticipation of a lane change or the like. Known blind spot detectors include active and passive infrared detectors, optical detectors, radar-based detectors, and the like.

### BRIEF DESCRIPTION OF THE DRAWINGS

The detailed description is described with reference to the accompanying figures.

The same numbers are used throughout the drawings to reference like features and components.

FIG. 1 is a right side view of a saddle type vehicle as per one embodiment of the present invention.

FIG. 2 is a block diagram for a blind spot detection system as per one embodiment of the present invention

FIG. 2a is a top view of the vehicle with blind spot area as per one embodiment of the present invention.

FIG. 2b is a top view of the vehicle with blind spot sensors as per one embodiment of the present invention.

FIG. 2c is top view of the saddle type vehicle with blind spot sensors vision cone as per one embodiment of the present invention.

FIG. 2d is top view of the straddle type vehicle with blind spot sensors vision cone as per one embodiment of the present invention.

FIG. 2e is a predetermined range of sensors with respect to location area as per one embodiment of the present invention.

FIG. 3 is a vehicle view as per one embodiment of the present invention.

FIG. 3a is a leaning vehicle view at predetermined angle as per one embodiment of the present invention.

FIG. 3b is conventional method view as per present invention.

FIG. 3c is a rear blind spot sensor view during vehicle leaning as per one embodiment of the present invention.

FIG. 4 is a flowchart as per one embodiment of the present invention.

### DETAILED DESCRIPTION

Driving a vehicle in modern traffic conditions is a very complicated and dangerous task. The rider must be aware of all oncoming road hazards and traffic control devices including stopped cars, pedestrians crossing and red lights. Highway driving poses a dangerous task of watching oncoming road hazards while at the same time keeping a watch on vehicles coming from back or sides while travelling at high speeds. This significantly reduces the fraction of time available to sight the objects, analyses and process information for the human brain and take required decisions in a moment. It is necessary to look both sideways and backwards before safely changing lanes on a highway. A failure to properly look both sideways and backwards before changing lanes can lead to serious high speed accidents. Such accidents often cause serious bodily harm or death.

A major cause of driving accidents is a rider's inability to recognize that another vehicle is proximate the rider's vehicle and that it is therefore unsafe to change lanes. The most difficult area for a rider to monitor is the rider's blind spot. Blind spots are attributable to, among other things, voids in coverage provided by mirrors that are positioned on the vehicle and by visual interference caused by objects (e.g. a part of the vehicle or an object being transported thereon or therein) which are located in the rider's line of vision.

Blind spots are traditionally monitored by the rider turning his head from the forward direction of travel of the vehicle to directly view the area in question. This is typically performed to determine whether another vehicle is proximate the rider's vehicle. In order for the rider to determine whether it is safe to change lanes, the rider must determine not only if a vehicle is present in the blind spot, but the size of the vehicle and its relative speed. This can only be accomplished if the rider observes the blind spot, and the vehicle that is in the blind spot, for a period of time (typically a few milliseconds). By turning his head from the forward direction of travel and observing the blind spot, the rider is reducing the chance of getting into an accident with a vehicle that is next to the rider's vehicle when changing lanes. However, since the rider is not continually observing roadway that is in front of the vehicle, the likelihood of the rider's vehicle being involved in a frontal collision increases.

In such cases, rearview mirrors located both inside the windshield, on the sides of vehicles so far have been the only widely accepted means for detecting vehicles on the sides or behind the rider's vehicle in the case of four wheeler. In case of two wheeler rear view mirrors are typically located on handle bar assembly for detecting vehicles on the side or behind the rider's vehicle. However, comparing blind spot area in four wheeler and in two wheeled vehicle, two wheeled vehicle has more blind spot area. Also, two wheeler riders are more prone to accident as compared to the four wheeler rider. All such rear view mirrors known to the applicant leave at least one blind spot where the rider cannot detect a nearby vehicle. These blind spots generally exist for example, right next to the rear fenders of a car or next to the rear wheels of a truck or on both sides of the two wheeled vehicles. Sometimes an entire car or two wheeled can be driving right alongside the rider's vehicle totally undetectable by the rider even after checking his rear view mirrors.

Further, most of the causes of blind spot in the two wheeled include, predominant sight of the forward vision which is an area the rider can see while riding the vehicle. The forward region comprises of sight zone and a peripheral zone. due to use of helmet, vision of peripheral zone that is maximum visual field zone is reduced by small values on both the sides of the vehicle. This reduction varies from helmet to helmet and is mainly dependent on the helmet design. This in turn increases the blind zone in the saddle type vehicle e.g. a two-wheeled vehicle. As the forward vision is very limited in the two-wheeled vehicle and hence a system to eliminate various blind spots is needed.

Therefore, from the above mentioned paragraphs it is quite clear that the blind spot in the vehicle has been a threat to the life of the riders of the vehicle. The blind spot in the vehicle specially creates problem for the riders riding vehicle in developing countries which have significant traffic as well as developed economies involving high speed biking. The developing countries face problem of heavy unregulated traffic which creates safety risk for the riders of the vehicle. Further, the blind spot in the vehicle leaves an open non visualized area, that is, the area which is not in the visual range of the riders. Also, in that particular area the riders are unable to see the approaching vehicles from either sides or rear side of the vehicle. Hence, one solution proposed for this problem is to use rear view mirror in the vehicle. However, during cornering of the vehicle, the blind spot area shifts, hence, having rear view mirror also does not effectively work. Using the rear-view mirror as a blind spot detector, the rider has to keep in mind the location of the mirror, shape and size of the mirror, orientation of the mirror. Further, as the rear view of the vehicle is not constant during leaning or cornering of the vehicle, hence at that point of time also, the mirrors do not cover the blind spot of the vehicle. Additional problems like vibration of the mirror at high speed occurs and also, when the rider is riding vehicle in high speed, then the rider may not get sufficient reaction time to avoid the obstacle thereby resulting into collision or accident. Further, taking reference of novice riders, there is always a fear/anxiety associated with the novice riders while riding in a dense traffic condition in the developing country as well as on high speed highways in developed economies. Therefore, there is a need of a blind spot detection system which detects the blind spot in the vehicle irrespective of the sides of the vehicle.

Further, another system for detecting blind spot area is active and passive infrared detectors, optical detectors, radar-based detectors, and the like. A blind spot detection system requires a user interface in order to inform the user that an object is in the rider's blind spot area. In order to be most effective, such user interface should be natural and provide an intuitive warning to the user. One known art approach has been to provide a series of indication lights on exterior mirror on the same side of the vehicle being protected by a blind spot detector. Alternatively, a display system may be mounted inside the vehicle compartment, but on the pillar adjacent the exterior rearview mirror. Such positioning of the display, on or adjacent to, the exterior/primary rearview mirror provides association with the side of the vehicle being covered by the blind spot detector. The primary rear-view mirror is typically glanced by the rider to perform any pre-maneuver evaluation. As the rider and his vision are processing considerable number of information while riding in a fraction of a second, it may be possible for the rider to overlook indications made by display systems associated with the blind spot indicator or the rearview mirror until late in the pre-maneuver evaluation. The presence of precipitation or road dirt on the display unit, window glass, canopy or the mirror itself may further reduce the clarity of indication to the rider.

In known art, a blind spot detection system is disclosed with mechanically aligned radar. With the help of a mechanical arrangement, the radar changes its orientation as the lean angle of the vehicle changes. This configuration enables the overcoming of the problem related to the change of blind spot area due to leaning of the vehicle. However, this configuration is only limited to the detection of blind spot area at the rear side of the vehicle. Additional problem, for example, blind spot area on the sides of the vehicle still exists in this configuration.

In another known art, radar is placed on the rear of the vehicle to monitor the rear blind spot area and offers an alert to the rider based on time to collision estimation. This system has its own limitation that the blind spot detection system will work only when the vehicle crosses threshold speed. Thereby, this raises additional problem for the vehicle moving slowly on road because of dense traffic. As in that case the disclosed blind spot detection system will not be able to detect the approaching vehicle hence, it raises safety risk for the riders.

Further, in another known art, a camera is placed on the back side of the helmet to give a view of the road traffic on the rear of the vehicle. The view is projected to the rider on the Helmet's visor with the help of a Heads-Up display. The solution as disclosed to detect the blind spot has its own limitation, like as, helmet is generally not stable and hence, will create problem for the riders while riding the vehicle.

Furthermore, in another known art, a center blind spot mirror with a wide angle is mounted in front direction of the vehicle. This however solves the problem of blind spot area at the rear side of the vehicle. But does not cover the side blind spots area in the vehicle.

Hence, there exists a challenge of designing a blind spot detection system, which can satisfactorily covers all side of the vehicle and removes blind spot area in the vehicle, thereby increasing riders safety in a dense traffic also and overcoming all problems of known art. Additionally there exists a challenge of designing a blind spot detection system which can work irrespective of the vehicle speed.

Therefore, there is a need to have an improved blind spot detection system which overcomes all of the above problems and other problems known in art.

The present subject matter discloses a blind spot detection system having sensor unit and an alert indication unit to ensure coverage of blind spot area in the vehicle from all sides while ensuring safety of the riders.

As per one aspect of the present invention, a vehicle comprising a blind spot detection system is disclosed. The blind spot detection system includes a sensor unit having blind spot sensors, a controller and an alert indication unit. Further, as per one aspect of the present invention, the blind spot sensors are located to cover blind spot areas of the vehicle, for example, at least one blind spot sensor in left side of the vehicle, at least one blind spot sensor in right side of the vehicle and a single sensor at the rear side of the vehicle. Further, as per one aspect of the present invention, a DC power supply device provides power to the blind spot detection system provided in the vehicle.

Further, as per one aspect of the present invention, the blind spot sensors as disposed on the sides of the vehicle, senses the obstacle approaching the vehicle and hence sends signal to the controller where the system works on Time of flight principle. The time of flight principle is defined as a method for measuring a distance between a sensor and an object, based on the time difference between the emission of a signal and its return to the sensor, after being reflected by the object. So here, the controller after receiving the output signal from the blind spot sensors computes the distance, velocity and angle of detected vehicles/obstacles. If the vehicle/obstacles fall in the blind spot areas of the vehicle, the controller sends an alert signal to respective alert indication unit, i.e., left or right indication unit based on the presence of obstacles/vehicles. Hence, the alert indication unit indicates to the riders about the approaching obstacles\vehicles with the direction specific information. This configuration assists to protect the riders from accident, collision etc. The configuration as explained above also covers the blind spot detection during cornering or leaning of the vehicle, thereby ensuring the safety of the riders.

The below paragraph further elaborates on the methodology used by the controller of the blind spot detection system. As per one aspect of the present invention, when the vehicle starts, the controller receives raw signal generated by the blind spot sensors located on the vehicle regarding the approaching or surrounding vehicle/obstacles. Subsequently, the controller analyzes the received raw signal from the blind spot sensors. After analyzing the received raw signal with respect to the velocity, distance and angle of the approaching or surrounding vehicle/obstacles, the controller decides whether the approaching vehicle is an obstacle. If there is an obstacle, controller further checks the status of left, right and rear blind spot sensor. If the obstacle is detected by at least one of the left blind spot sensor, controller issues an alert to the rider through suitable means, for example, alert indication unit by activating the left alert indicator or collision unit. If the obstacle is detected by at least one of the right blind spot sensor, controller issues an alert to the rider by activating the right alert indicator or collision unit.

If the obstacle is detected by the rear blind spot sensor, controller analyzes whether the obstacle is approaching towards left side of the vehicle from rear side of the vehicle or approaching towards right side of the vehicle from the rear side of the vehicle. If it is approaching from the left, the left indicator unit flashes continuously to indicate its presence. If it is approaching from the right, the right indicator unit flashes continuously to indicate its presence. In some cases, the obstacle is detected by at least one of the left & right blind spot sensor as well as the rear blind spot sensor, then the glowing intensity of the alert indicator increases to indicate a higher risk. Similarly, if the obstacle is detected on both left & right side of the vehicle, both the alert indicator will glow to indicate the presence of obstacle on both the sides. In one implementation, alert indication unit can be also a visual or audio alert. The visual alert can be a led indicator placed on a location on vehicle which is in the field of view of the rider while riding the saddle type vehicle e.g. two wheeled vehicle. Audio indicator can also be utilised and placed inside the helmet to give voice based assistance.

Further, as per another aspect of the present invention, a blind spot detection system includes a sensor unit, a controller, an alert indication unit and a switch. The switch as located provides ease of accessibility of the left and right blind spot sensor where the riders can manually activates the sensors depending on the traffic density on the road.

In the ensuing exemplary aspects, the vehicle is a two wheeled saddle type vehicle. However, it is contemplated that the concepts of the present invention may be applied to any of the two wheeled, three wheeled and four wheeled type vehicle.

The various other features of the invention are described in detail below with an embodiment of a two wheeled vehicle with reference to the accompanying drawings. In the drawings, like reference numbers generally indicate identical, functionally similar, and/or structurally similar elements. The drawing in which an element first appears is indicated by the leftmost digit(s) in the corresponding reference number. With reference to the accompanying drawings, wherein the same reference numerals will be used to identify the same or similar elements throughout the several views. The present subject matter is further described with reference to accompanying figures. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

Further “front” and “rear”, and “left” and “right” referred to in the ensuring description of the illustrated embodiment refer to front and rear, and left and right directions as seen in a state of being seated on a seat of the saddle type vehicle. Furthermore, a longitudinal axis refers to a front to rear axis relative to the vehicle, while a lateral axis refers to a side to side, or left to right axis relative to the vehicle. Also, it is to be understood that the phraseology and terminology used herein is for the purpose of description and should not be regarded as limiting.

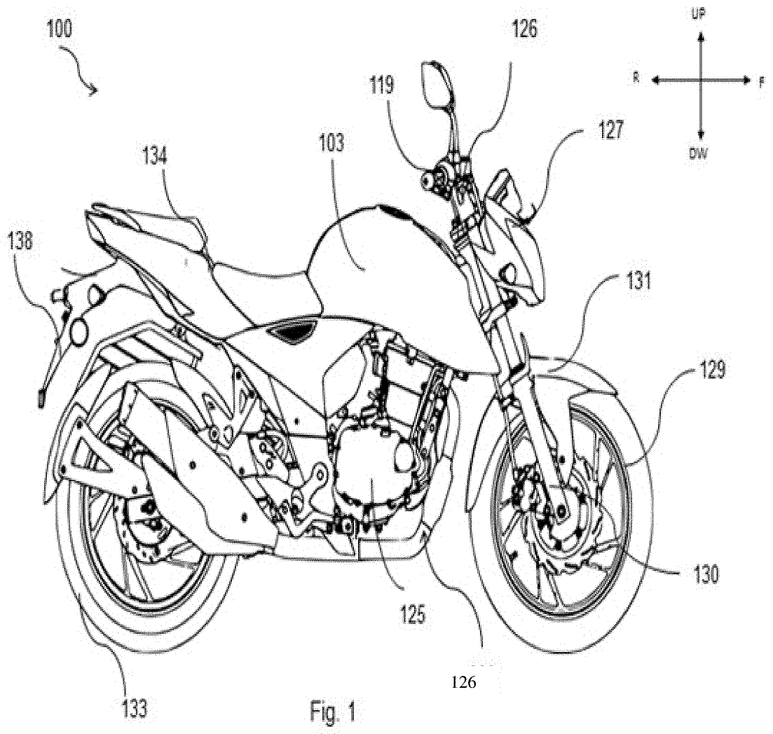

FIG. 1 is a right side view of an exemplary saddle type vehicle. The vehicle (100) has a frame assembly (not shown), which acts as the skeleton for bearing the loads. Instrument cluster (119) is mounted on handle bar assembly (126). The handle bar assembly (126) is disposed over the head tube (not shown) and it includes brake levers (not shown). The handle bar assembly (126) is connected to a front wheel (129) by one or more front suspension(s) (130). A front fender (131) is disposed above the front wheel (129) for covering at least a portion of the front wheel (129). A fuel tank (103) is mounted to the main tube (not shown) of the frame (not shown) and it is disposed in the front portion F of a space of the frame (not shown). The vehicle (100) having lighting means which includes Head lamp (127), Tail lamp (not shown), Turning indicators includes front side indicators (not shown) and rear side indicator (not shown) respectively. A rear fender (138) is projected outwardly of the vehicle systems and protects pillion from mud splash as well as to protect the rear wheel (133) from external components. A power unit (125) is mounted to the lower portion of the vehicle (100). In an embodiment, the power unit (125) is an IC engine. The fuel tank (103) is functionally connected to the engine (125). The seat (132) is located at the back region of the fuel tank (103) and is extended in a longitudinal direction along the seat frames. As per one embodiment of the present invention, an exhaust system (126) is connected to the engine (125) and extended rearwardly of the vehicle (100).

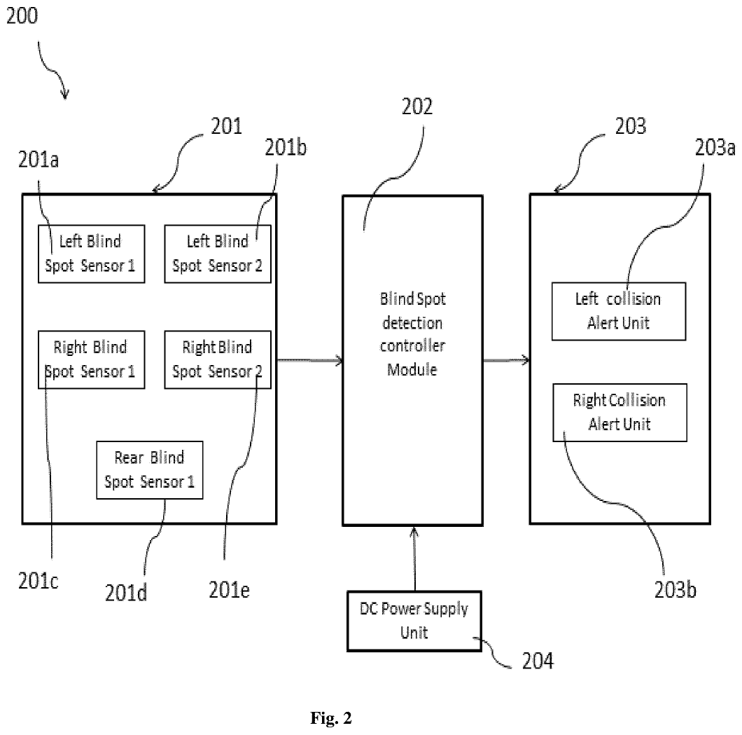

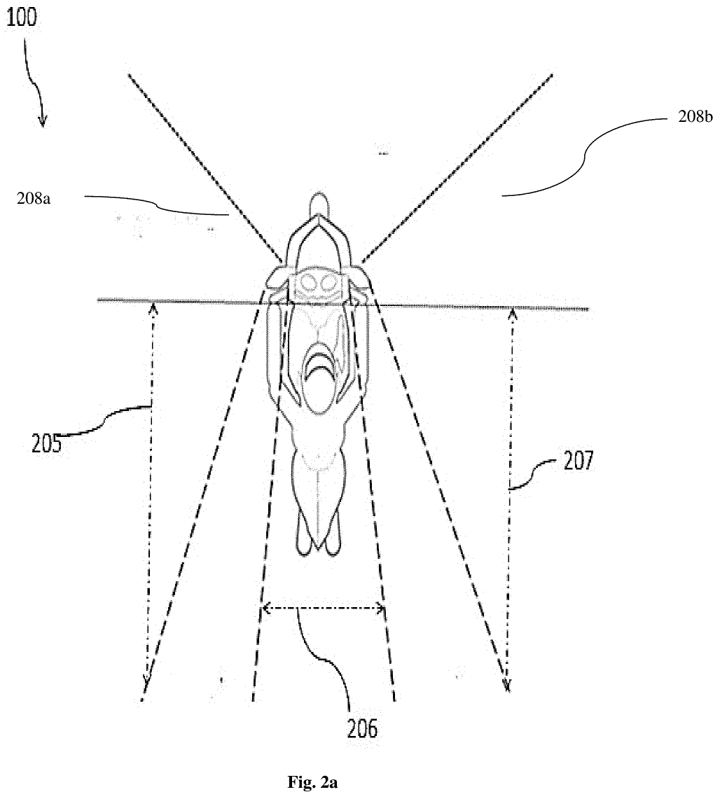

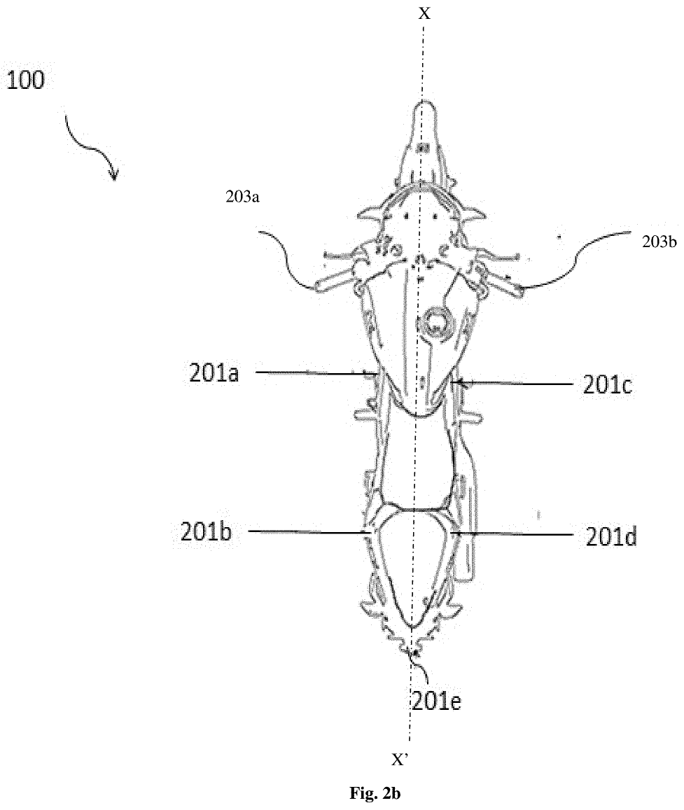

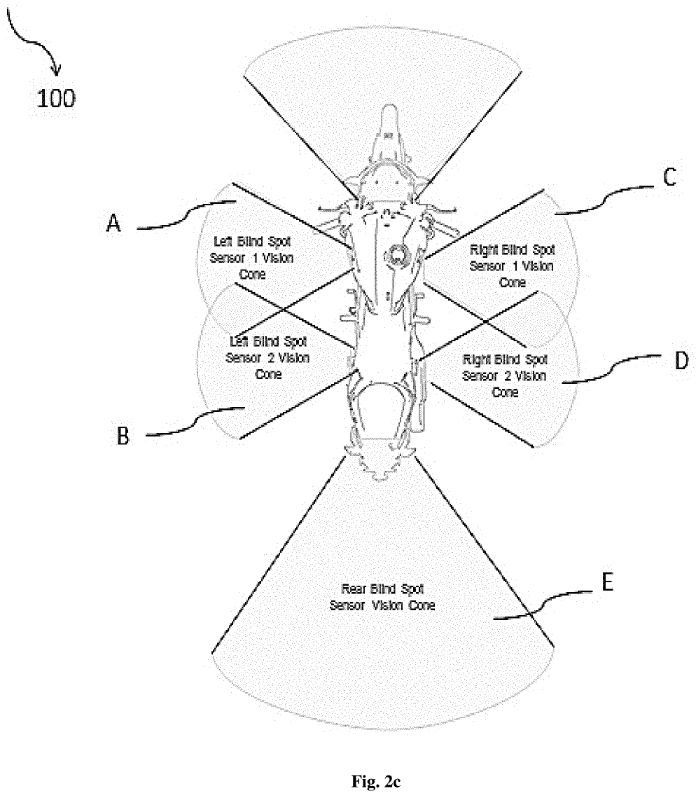

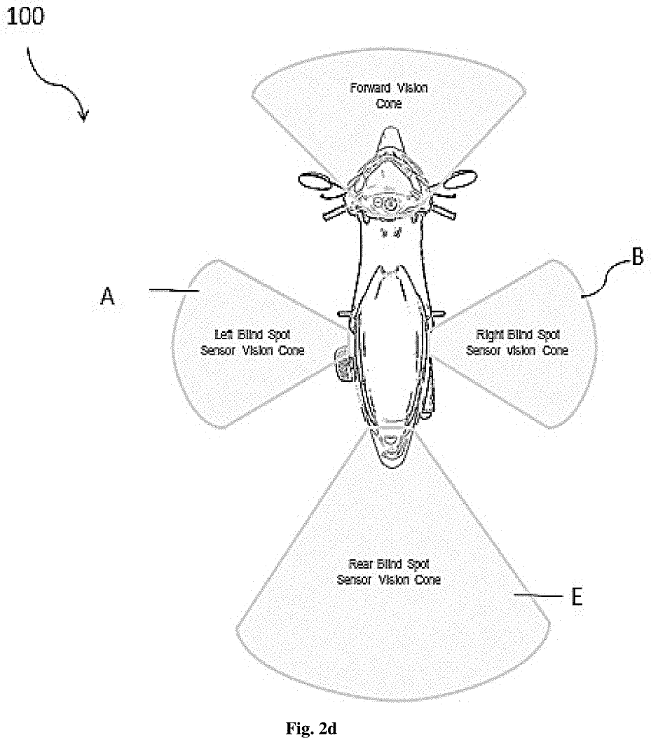

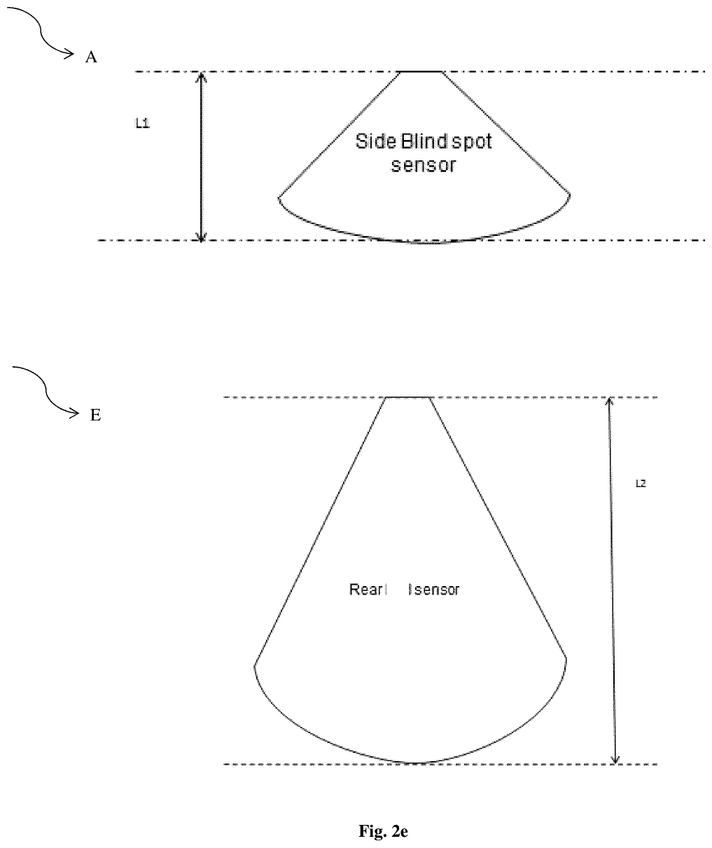

FIG. 2 is a block diagram for a blind spot detection system as per one embodiment of the present invention. The blind spot detection system (200) includes sensor unit (201) having blind spot sensors (201a, 201b, 201c, 201d, and 201e), a controller (202) and an alert indication unit (203). The alert indication unit (203) includes a left collision alert unit (203a) and a right collision alert unit (203b). As per one implementation, the left collision alert unit (203a) and the right collision alert unit (203b) is located on the handle bar assembly of the vehicle. As per another implementation, indicator to the riders can be given as a visual alert indicator can also be placed on instrument cluster. Further, as per one embodiment of the present invention, the blind spot sensors (201a, 201b, 201c, 201d, and 201e) are located to cover blind spot areas (205, 206 and 207) of the vehicle (as shown in FIG. 2b), where the blind spot region is shown in FIG. 2a. Further, for example, at least one blind spot sensor (201a, 201b) is located on left side of the vehicle, at least one blind spot sensor (201c, 201d) is located on right side of the vehicle and a single sensor (201e) is located on rear side of the vehicle (as shown in FIG. 2b). As per one embodiment of the present invention, the left blind spot sensor 1 (201a) is located on the side of the fuel tank (103) of the vehicle (100) and the left blind spot sensor 2 (201b) is located on the left side substantially below the rear pillion seat of the vehicle. Further, the left blind spot sensor 1 (201a) and the left blind spot sensor 2 (201b) are disposed along the one side with respect to the longitudinal mid plane (XX′) of the vehicle. Further, as per one embodiment of the present invention, the right blind spot sensor 1 (201c) is located on the right side of the fuel tank (103) of the vehicle (100) and the right blind spot sensor 2 (201d) is located on the right side substantially below the rear pillion seat of the vehicle. Further, the right blind spot sensor 1 (201c) and the right blind spot sensor 2 (201d) are disposed along another side with respect to the mid plane (XX′) of the vehicle. The left blind spot sensor 1 (201a), the left blind spot sensor 2 (201b), the right blind spot sensor 1 (201c) and the right blind spot sensor 2 (201d) are also referred as side sensors of the vehicle. The rear blind spot sensor (201e) is located above the rear license plate mounting bracket in a vehicle. As per another implementation, at least a rear blind spot sensor is located above the rear license plate mounting bracket in a vehicle

Further, as per one embodiment of the present invention, the blind spot sensors (201a, 201b, 201c, 201d, and 201e) as disposed on the sides of the vehicle, senses the obstacle approaching the vehicle and hence sends signal to the controller (202) where the system works on Time of flight principle. The time of flight principle is defined as a method for measuring a distance between a sensor and an object, based on the time difference between the emission of a signal and its return to the sensor, after being reflected by the object. So here, the controller (202) after receiving the output signal from the blind spot sensors computes the distance, velocity and angle of detected vehicles/obstacles. If the vehicle/obstacles falls in the blind spot areas (205, 206 and 207) of the vehicle, the controller (202) sends an alert signal to respective alert indication unit, i.e., left or right indication unit (203a, 203b) based on the presence of obstacles/vehicles. Hence, the alert indication unit indicates to the riders about the approaching obstacles\vehicles with the direction specific information. This configuration assists to protect the riders from accident, collision etc. The configuration as explained above also covers the blind spot detection during cornering or leaning of the vehicle, thereby ensuring the safety of the riders.

The location of the side blind spot sensors depends on the various factors, for example, forward peripheral regions (208a, 208b) of the vehicle, length of the vehicle. The forward peripheral regions (208a, 208b) are inversely proportional to the side blind spot areas and the side blind spot areas are directly proportional to the number of sensors. For example, in a saddle type vehicle, forward peripheral region is less as the rider has a mobility restraint and legs of the rider are constrained near fuel tank of the vehicle. As the forward peripheral region is less, hence the side blind spot areas in the saddle type vehicle are more. Further, since the side blind spot areas are more in the saddle type vehicle, the number of blind spot sensors required are higher in the vehicle (as shown in FIG. 2c). Also, vision cone (A, B, C, D & E) generated by the blind spot sensors eliminates the blind spot areas (side blind spot areas and rear blind spot area) of the vehicle. Taking another case of straddle type vehicle according to same relation, forward peripheral region (208a, 208b) is more as compared to saddle type vehicle, as legs of the rider are freely movable, leading to increased mobility or increased degree of freedom for the human body to cover a wider vision cone. As the forward peripheral region is more, hence the side blind spot areas in the straddle type vehicle are less. Further, since, the side blind spot areas are less in the straddle type vehicle, the number of blind spot sensors located is lesser as compared to the saddle type vehicle (as shown in FIG. 2d). Also, vision cone (A, B & E) generated by the blind spot sensors covers the blind spot areas (side blind spot areas and rear blind spot area) and thus eliminates the blind spot areas in straddle type vehicle. Further, as per one embodiment of the present invention, DC power supply unit (204) provides power supply to the blind spot detection system (200) provided in the vehicle.

FIG. 2e is a predetermined range of vision cone of at least a sensor as per one embodiment of the present invention. Further, as per one embodiment of the present invention, the side blind spot sensors are an ultrasonic sensor and the rear blind spot sensor is a radar sensor. The vision cone of side blind spot sensor's detection range is in predetermined range L1. The predetermined range L1 is in range of 0-7 m with respect the location of sensor. Further, the vision cone of rear blind spot sensor's detection range is in predetermined L2. The predetermined range L2 is in range of 0-70 m with respect to the location of sensor. This ensures the coverage of the blind spot areas in the vehicle and also, ensures safety of the rider riding on the vehicle. As per another embodiment of the present invention, the sensors can be lidar sensors, camera etc.

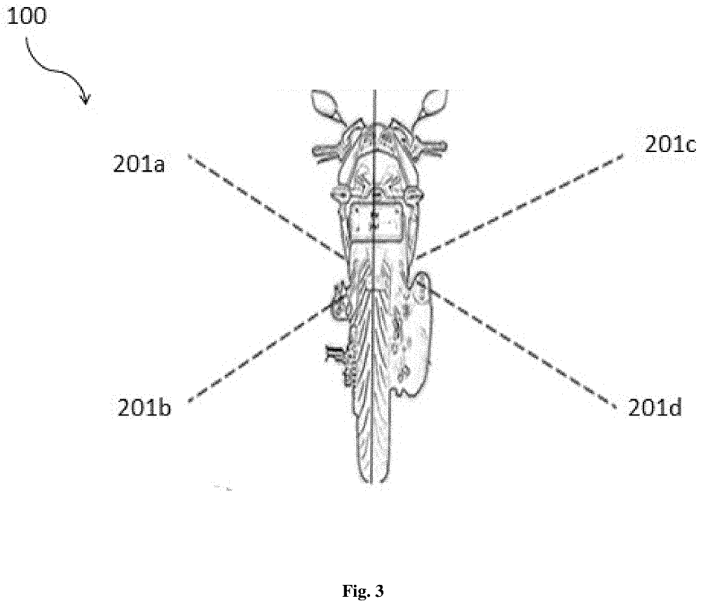

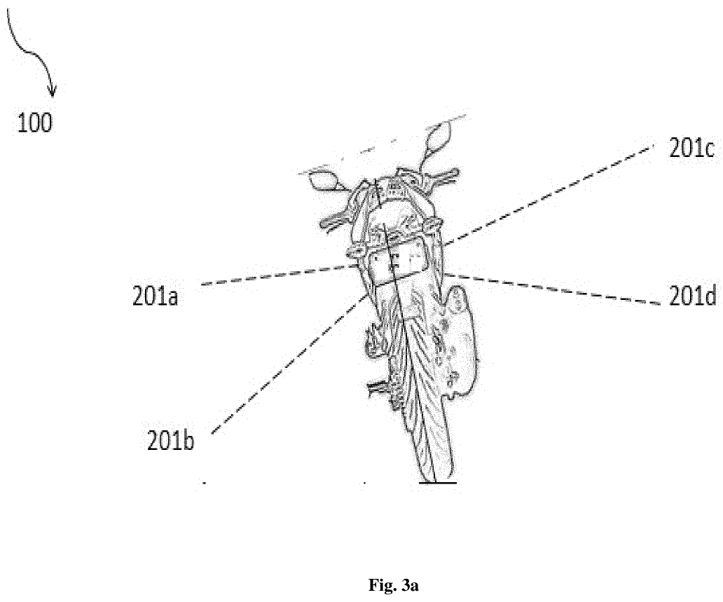

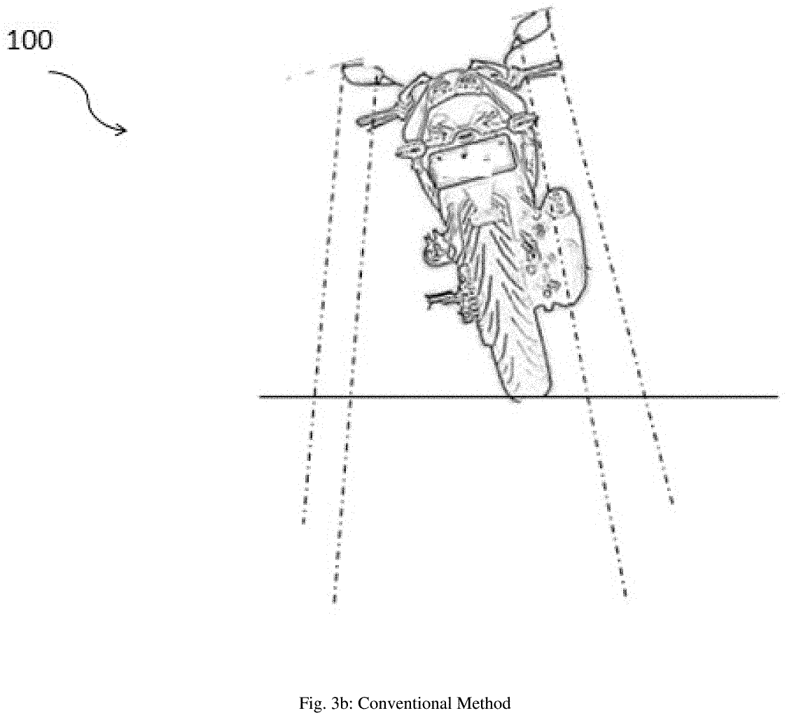

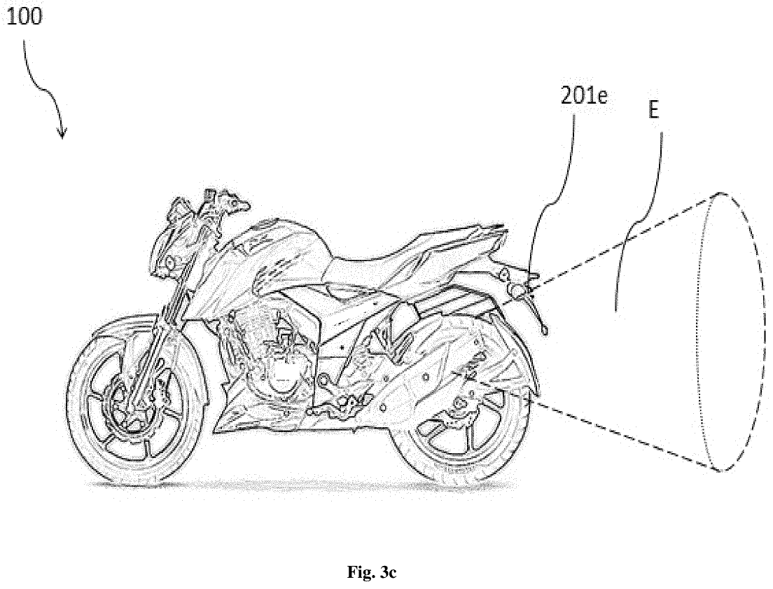

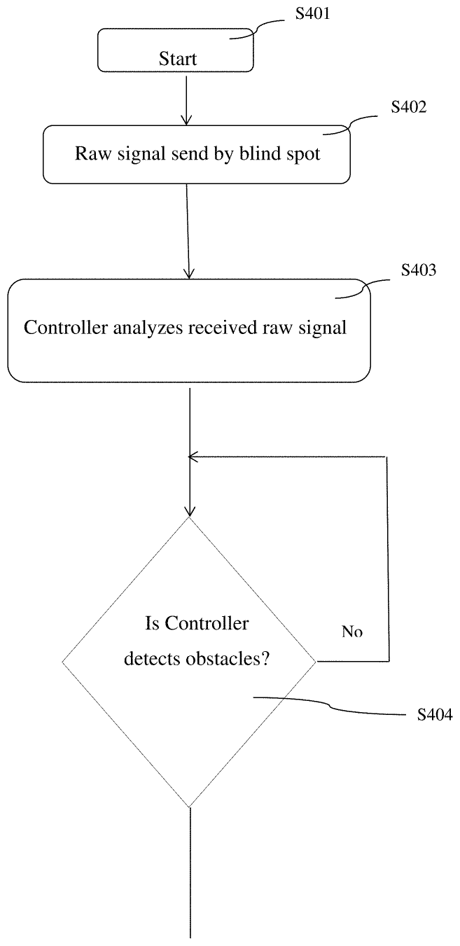

FIG. 3, 3a, 3c are a vehicle view at different angle as per one embodiment of the present invention. Further, as per one embodiment of the present invention, when the vehicle is static (as shown in FIG. 3), the side blind spot sensors cover blind spot area present in the side of the vehicle. As per one embodiment of the present invention, when the vehicle is leaning\cornering at predetermined angle, the blind spot area of the vehicle also shifts. Therefore, the side blind spot sensors covers the shifted blind spot area of the vehicle unlike as conventional method (as shown in FIG. 3b), where manual shifting of rear view mirror is required to make rider aware of the approaching vehicle in blind spot area. Further, as per one embodiment of the present invention, during leaning\cornering of the vehicle, the vision cone of the rear blind spot sensor remains same and covers the rear blind spot area of the vehicle during leaning\cornering of the vehicle. Hence, this configuration ensures protection of the vehicle from collision or accidents.

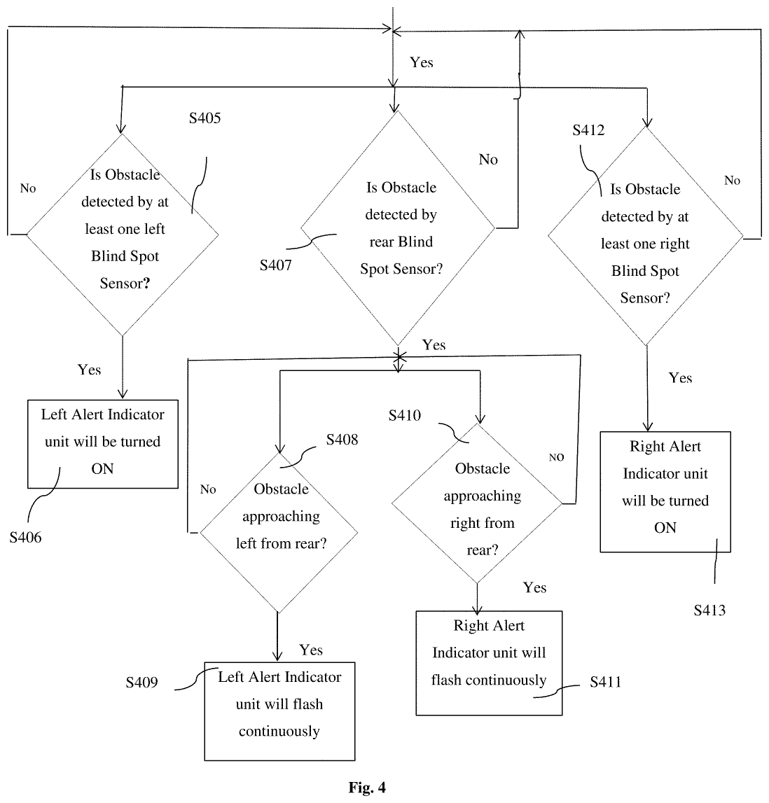

FIG. 4 is a flowchart explaining methodology for detection by blind spot detection system. As per one aspect of the present invention, when the vehicle starts (S401), the controller receives raw signal generated by the blind spot sensors located on the vehicle regarding the approaching or surrounding vehicle/obstacles (S402). Subsequently, the controller analyzes the received raw signal from the blind spot sensors (S403). After analyzing the received raw signal with respect to the velocity, distance and angle of the approaching or surrounding vehicle/obstacles, the controller decides whether the approaching vehicle is an obstacle (S404). If there is an obstacle, controller further checks the status of left, right and rear blind spot sensor. If the obstacle is detected by at least one of the left blind spot sensor (S405), controller issues an alert to the rider through suitable means, for example, alert indication unit by activating the left alert indicator or collision unit (S406). If the obstacle is detected by at least one of the right blind spot sensor (S412), controller issues an alert to the rider by activating the right alert indicator or collision unit (S413).

If the obstacle is detected by the rear blind spot sensor, controller analyzes whether the obstacle is approaching towards left side of the vehicle from rear side of the vehicle (S408) or approaching towards right side of the vehicle from the rear side of the vehicle (S410). If it is approaching from the left, the left indicator unit flashes continuously to indicate its presence (S409). If it is approaching from the right, the right indicator unit flashes continuously to indicate its presence (S411). In some cases, the obstacle is detected by at least one of the left & right blind spot sensor as well as the rear blind spot sensor, then the glowing intensity of the alert indicator increases to indicate a higher risk. Similarly, if the obstacle is located on both left & right side of the subject vehicle, both the alert indicator will glow to indicate the presence of obstacle on both the sides. In one implementation, alert indication unit can be also a visual or audio alert. The visual alert can be a led indicator placed on a location on vehicle which is in the field of view of the rider while riding the two-wheeler. Audio indicator can also be utilised and placed inside the helmet to give voice based assistance. As per alternate embodiments, the current invention can be implemented in a three or four wheeled vehicle to achieve a safe and robust blind spot recognition and alert mechanism for the user of the vehicle.

Further, as per another embodiment of the present invention, a blind spot detection system includes sensors, a controller, an alert indication unit and a switch disposed in an accessible region for the rider to access. The switch as located provides ease of accessibility of the left and right blind spot sensor where the rider can manually access the activation of the sensors depending on the traffic density on the road.

The embodiments explained in FIG. 2 and method explained in FIG. 4 of the present invention helps in ensuring the elimination of blind spot area in the vehicle as well as overcoming all the problems known in the art.

Advantageously, the embodiments of the present invention, describes the potential modifications in the blind spot detection system which covers and eliminates the blind spot area in the vehicle hence, ensuring safety for the riders. This facilitates the simple system which ensures the safety of the riders.

Many other improvements and modifications may be incorporated herein without deviating from the scope of the invention.

### LIST OF REFERENCE SYMBOL

### FIG. 1

100: Saddle type Vehicle
126: Handle Bar Assembly
119: Instrument Cluster
127: Head Lamp
131: Front Fender
129: Front Wheel
130: Front Suspension
125: Engine
103: Fuel Tank
134: Seat
138: Rear Fender
133: Rear Wheel
126: Exhaust System

### FIG. 2

200: Blind spot detection system
201 (201a, 201b, 201c, 201d, 201e): Sensors
202: Controller
203: Alert Indication Unit
203a; left Collision Alert Unit
203b: Right Collision Alert Unit

### FIG. 2a

205: Left Blind Spot Area
206: Rear Blind Spot Area
207: Right Blind Spot Area
208a, 208b: Forward Peripheral Region

FIG. 2c
A: Left Blind Spot Sensor 1 vision cone.
B: Left Blind Spot Sensor 2 vision cone
C: Right Blind Spot Sensor 1 vision cone
D; Right Blind Spot Sensor 2 vision cone
E: Rear Blind Spot sensor vision cone

FIG. 2e
L1: Predetermined range of Side Blind Spot Sensors
L2: Predetermined range of Rear Blind Spot Sensor

1-17. (canceled)

18. A blind spot detection system for a vehicle, the detection system comprising:
a sensor unit;
a controller; and
an alert indication unit, wherein
the sensor unit includes a left blind spot sensor, a right blind spot sensor and a rear blind spot sensor,
the left blind spot sensor is located on one side of the vehicle with respect to a longitudinal mid plane axis of the vehicle,
the right blind spot sensor is located on another side of the vehicle with respect to the longitudinal mid plane axis of the vehicle,
the left blind spot sensor and the right blind spot sensor are located to detect objects in blind spot areas of the vehicle, and
the rear blind spot sensor is located rearwardly of the vehicle and located to detect objects in blind spot areas.

19. The blind spot detection system as claimed in claim 18, wherein
the vehicle includes a fuel tank and a rear pillion seat, and
the left blind spot sensor is located on a left side of the fuel tank with respect to the longitudinal mid plane axis of the vehicle.

20. The blind spot detection system as claimed in claim 19, wherein
the left blind spot sensor is located below the rear pillion seat of the vehicle with respect to the longitudinal mid plane axis of the vehicle.

21. The blind spot detection system as claimed in claim 19, wherein the right blind spot sensor is located on a right side of the fuel tank of the vehicle with respect to the longitudinal mid plane axis of the vehicle.

22. The blind spot detection system as claimed in claim 19, wherein the right blind spot sensor is located on a right side below the rear pillion seat of the vehicle with respect to the longitudinal mid plane axis of the vehicle.

23. The blind spot detection system as claimed in claim 18, wherein the sensor unit is electrically connected to the controller and the controller is electrically connected to the alert indication unit.

24. The blind spot detection system as claimed in claim 23, wherein the alert indication unit is an audio or visual alert indication unit which provides an alert to a rider of the vehicle.

25. The blind spot detection system as claimed in claim 18, further comprising:
a switch disposed in an accessible region for a rider to access the left blind spot sensor and the right blind spot sensor in the vehicle.

26. The blind spot detection system as claimed in claim 18, wherein
the left blind spot sensor and the right blind spot sensor have a plurality of vision cones, and
the vision cones have a detection region in a predetermined range with respect to locations of the left blind spot sensor and the right blind spot sensor.

27. The blind spot detection system as claimed in claim 26, wherein the predetermined range is in range of 0 meter to 7 meters.

28. The blind spot detection system as claimed in claim 18, wherein
the rear blind spot sensor has a vision cone, and
the vision cone has a detection region in a predetermined range with respect to a location of the rear blind spot sensor.

29. The blind spot detection system as claimed in claim 28, wherein the predetermined range is in range of 0 meter to 70 meters.

30. The blind spot detection sensor as claimed in claim 18, wherein each of the left blind spot sensor and the right blind spot sensor is an ultrasonic sensor.

31. The blind spot detection sensor as claimed in claim 28, wherein the rear blind sensor is a radar sensor.

32. A method for detection of an obstacle approaching in a blind spot area by a blind spot detection system for a vehicle, the method comprising:
starting the vehicle;
sending raw signals to a controller from a left blind spot sensor, a right blind spot sensor and a rear blind spot sensor;
analyzing the raw signals by the controller;
deciding whether an approaching vehicle is the obstacle and checking statuses of the left blind spot sensor, the right blind spot sensor and the rear blind spot sensor;
detecting the obstacle by the left blind spot sensor;
communicating an alert to a rider through a left alert indicator or a collision unit, when the obstacle is detected by the left spot sensor;
detecting the obstacle by the right blind spot sensor;
communicating an alert to the rider through a right alert indicator or the collision unit, when the obstacle is detected by the right blind spot sensor;
detecting the obstacle by the rear blind spot sensor;
analyzing whether the obstacle approaching a left side of the vehicle from a rear side of the vehicle;
communicating an alert to the rider through the left alert indicator or the collision unit;
analyzing whether the obstacle approaching a right side of the vehicle from the rear side of the vehicle; and
communicating an alert to the rider through the right alert indicator or the collision unit.

33. The method for the vehicle as claimed in claim 32, wherein when the obstacle is detected by one of the left blind spot sensor and the right blind spot sensor as well as the rear blind spot sensor, a glowing intensity of the left or right alert indicator or the collision unit increases to indicate a higher risk to the rider of the vehicle.

34. The method for the vehicle as claimed in claim 32, wherein when the obstacle is detected by the left blind spot sensor and the right blind spot sensor, the left alert indicator or the collision unit and the right alert indicator or the collision unit glow to indicate presence of the obstacle on both sides to the rider of the vehicle.
